(19) United States
(12) Patent Application Publication
(10) Pub. No.: US 2017/0035230 A1
(43) Pub. Date: Feb. 9, 2017

(54) Inventory Tracking Assembly

(71) Applicant: Mark Chapman, Charlotte, NC (US)

(72) Inventor: Mark Chapman, Charlotte, NC (US)

(21) Appl. No.: 14/820,966

(22) Filed: Aug. 7, 2015

(51) Int. Cl. A47G 25/14; G06K 7/10; G06Q 50/10; B65D 85/18; G06Q 10/08

(52) U.S. Cl. CPC A47G 25/1407; B65D 85/18; G06Q 10/087; G06Q 50/10; G06K 7/10366

(57) ABSTRACT

An inventory tracking assembly includes a holder that may restrain an article of clothing. A tracking unit is coupled to the holder and the tracking unit stores information pertaining to the article of clothing. The tracking unit displays the information such that the tracking unit may communicate the information to a user thereby facilitating the article of clothing to be tracked and identified.

### BACKGROUND OF THE DISCLOSURE

### Field of the Disclosure

The disclosure relates to tracking devices and more particularly pertains to a new tracking device for PURPOSE.

### SUMMARY OF THE DISCLOSURE

An embodiment of the disclosure meets the needs presented above by generally comprising a holder that may restrain an article of clothing. A tracking unit is coupled to the holder and the tracking unit stores information pertaining to the article of clothing. The tracking unit displays the information such that the tracking unit may communicate the information to a user thereby facilitating the article of clothing to be tracked and identified.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of an inventory tracking assembly according to an embodiment of the disclosure.

FIG. 2 is a front view of an embodiment of the disclosure.

FIG. 3 is a top perspective view of an embodiment of the disclosure.

FIG. 4 is an exploded perspective view of an embodiment of the disclosure.

FIG. 5 is a schematic view of an embodiment of the disclosure.

### DESCRIPTION OF THE PREFERRED EMBODIMENT

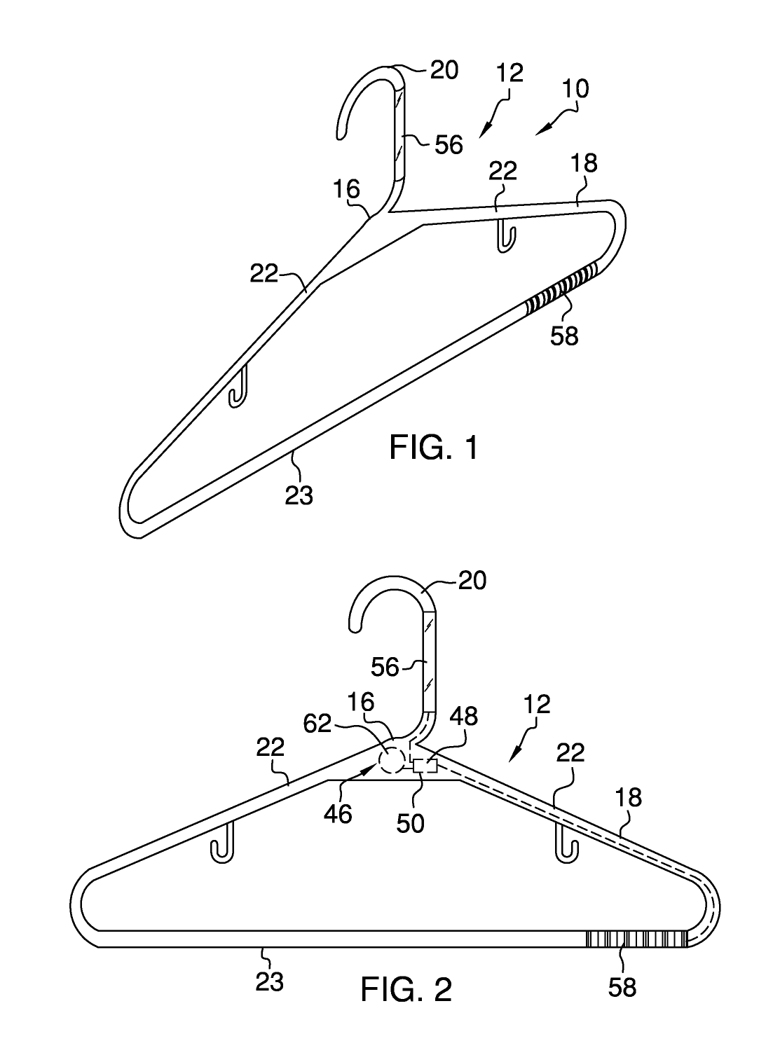

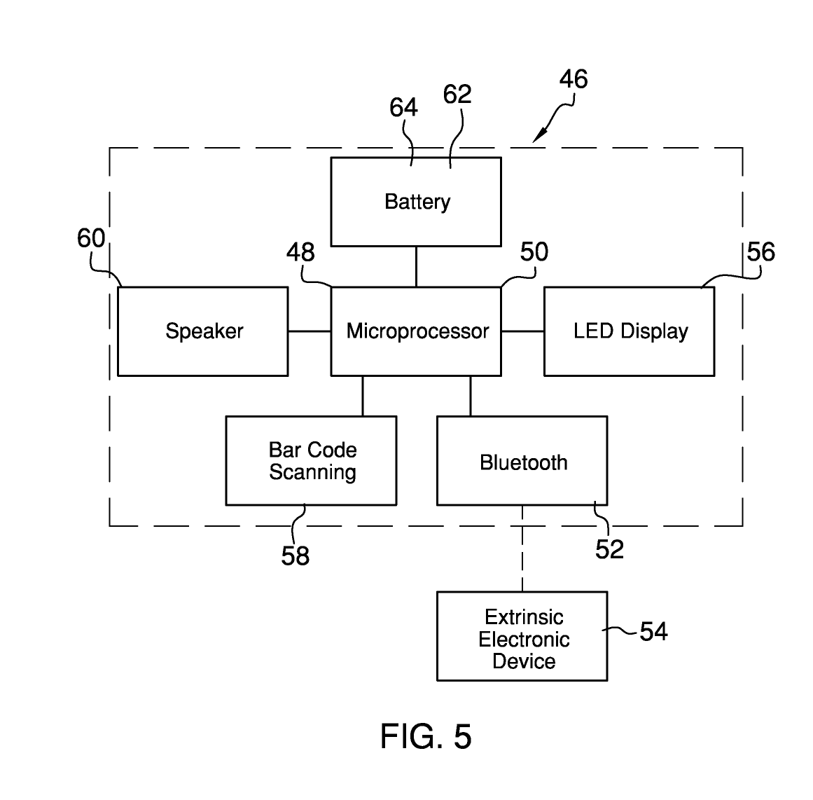

With reference now to the drawings, and in particular to FIGS. 1 through 5 thereof, a new tracking device embodying the principles and concepts of an embodiment of the disclosure and generally designated by the reference numeral 10 will be described.

As best illustrated in FIGS. 1 through 5, the inventory tracking assembly 10 generally comprises a holder 12 that may restrain an article of clothing 14. The holder 12 comprises a clothes hanger 16 that has a body 18 and a hook 20. The body 18 has a pair of upper members 22 coupled to and extending away from a lower member 23 and the body 18 may have the article of clothing 14 suspended therefrom. The hook 20 extends upwardly from the body 18 such that the hook 20 may be suspended from a support.

The holder 12 additionally comprises a plurality of boxes 24 and each of the boxes 24 has a drawer 26 that is slidably coupled thereto. Each of the boxes 24 has a front end 28 and a peripheral wall 30. The front end 28 is open and the peripheral wall 30 has a top side 32, a bottom side 34 and a first lateral side 36. The drawer 26 slides outwardly from the front end 28. The drawer 26 has a front wall 38 and the front wall 38 covers the front end 28 when the drawer 26 is closed. The drawer 26 may contain the article of clothing 14.

The top side 32 has a plurality of wells 40 extending downwardly therein. Each of the wells 40 is positioned adjacent to an associated one of four corners 42 of the box 24. Each of the boxes 24 includes a plurality of couplers 44 and each of the couplers 44 is coupled to the bottom side 34. Each of the couplers 44 is positioned adjacent to an associated one of the four corners 42. Each of the couplers 44 on one of the boxes 24 is complementary with respect to each of the wells 40 on one of the boxes 24 thereby facilitating the boxes 24 to be stacked. Each of the couplers 44 may comprise a magnet or the like and each of the couplers 44 may magnetically engage the associated well 40.

A tracking unit 46 is coupled to the holder 12 and the tracking unit 46 stores information pertaining to the article of clothing 14. The tracking unit 46 displays the information such that the tracking unit 46 may communicate the information to a user. Thus, the article of clothing 14 may be tracked and identified. The tracking unit 46 comprises a control circuit 48 that is coupled to the holder 12. The control circuit 48 includes an electronic memory 50 and the electronic memory 50 stores the information. The control circuit 48 converts the information into a barcode.

A transceiver 52 is coupled to the holder 12 and the tracking unit 52 is electrically coupled to the control circuit 48. The transceiver 52 may be in electrical communication with an extrinsic electronic device 54 thereby facilitating the electronic memory 50 to receive the information. The extrinsic electronic device 54 may comprise a Smart Phone or the like. The transceiver 52 may comprise a radio frequency transceiver or the like. The transceiver 52 may utilize a Bluetooth signal or other WPAN signal. The control circuit 48 receives a location command from the extrinsic electronic device 54.

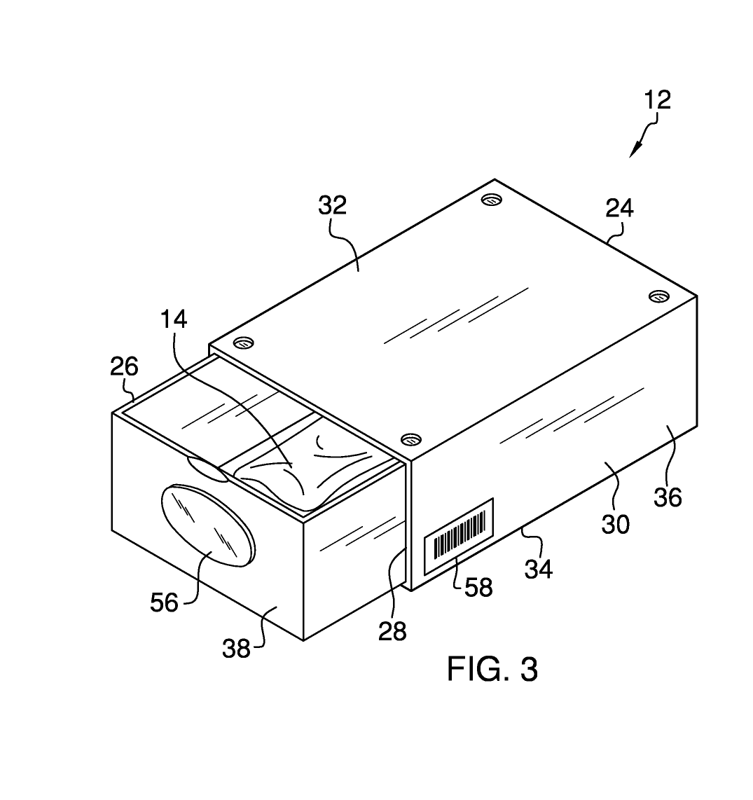

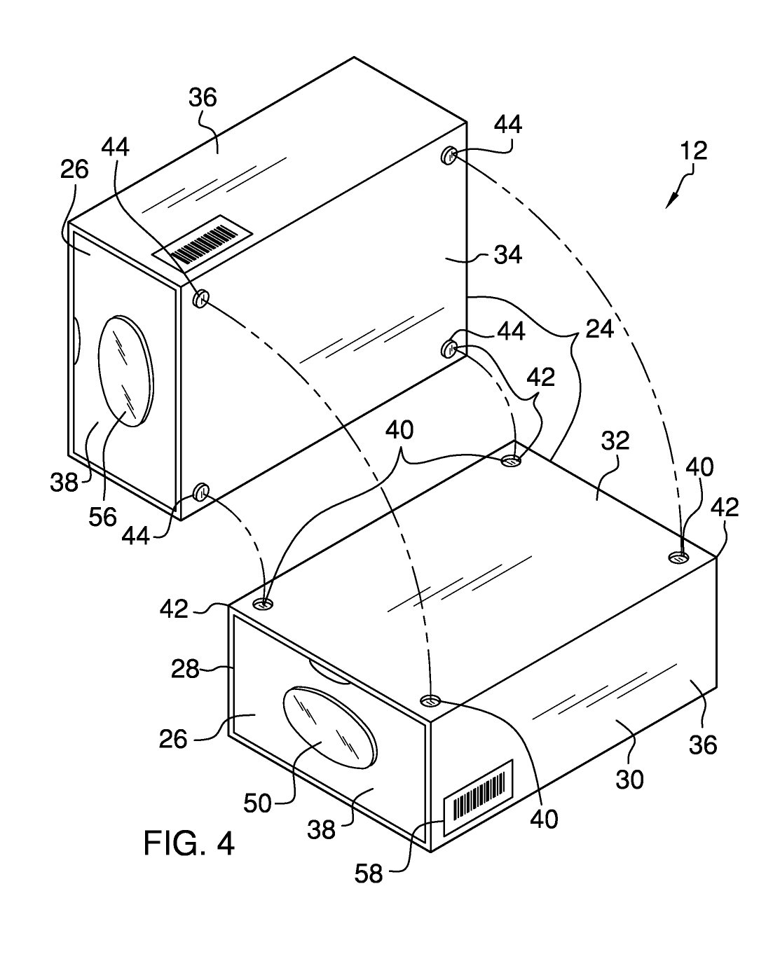

A light emitter 56 is coupled to the holder 12 such that the light emitter 56 may be visible to the user. The light emitter 56 is electrically coupled to the control circuit 48 such that the light emitter 56 emits light when the control circuit 48 receives the location command. Thus, the user may visually locate the holder 12. The light emitter 56 may comprise an LED or the like. As show in FIGS. 1 and 2, the light emitter 56 is positioned on the hook 20 of the clothes hanger 16. As shown in FIGS. 3 and 4, the light emitter 56 is positioned on the front wall 38 of the drawer 26.

A display 58 is coupled to the holder 12 and the display 58 is electrically coupled to the control circuit 48. Thus, the display 58 may display the barcode thereby facilitating the barcode to be scanned into an inventory tracker or the like. The display 58 may comprise an LCD or the like. As shown in FIGS. 1 and 2, the display 58 may be positioned on the lower member 23 of the clothes hanger 16. As shown in FIGS. 3 and 4, the display 58 may be positioned on the first lateral side 36 of the boxes 24.

A speaker 60 is coupled to the holder 12 and the speaker 60 is electrically coupled to the control circuit 48. The speaker 60 emits an audible alert when the control circuit 48 receives the location command. Thus, the user may audibly locate the holder 12. A power supply 62 is positioned within the holder 12. The power supply 62 is electrically coupled to the control circuit 48 and the power supply 62 comprises at least one battery 64.

In use, the extrinsic electronic device 54 communicates information pertaining to the article of clothing 14 to the control circuit 48. The light emitter 56 emits light when control circuit 48 receives the location command thereby facilitating the user to locate the holder 12. Additionally, the speaker 60 emits the audible alert when the control circuit 48 receives the location command. The display 58 constantly displays the barcode thereby facilitating the article of clothing 14 to be tracked and inventoried.

The clothes hanger 16 is positioned on the support and the clothes hanger 16 supports the article of clothing 14. The clothes hanger 16 may be one of a plurality of clothes hangers 16 and the clothes hangers 16 may be distributed on the support. The light emitter 56 and the speaker 60 on each of the clothes hangers 16 facilitate the associated article of clothing 14 to be located. The article of clothing 14 may be placed within the drawer 26 and the boxes 24 may be stacked. The light emitter 56 and the speaker 60 on each of the boxes 24 facilitate the associated article of clothing 14 to be located.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An inventory tracking assembly comprising:
a holder being configured to restrain an article of clothing;
a tracking unit being coupled to said holder, said tracking unit being configured to store information pertaining to the article of clothing, said tracking unit displaying the information wherein said tracking unit is configured to communicate the information to a user thereby facilitating the article of clothing to be tracked and identified; and
wherein said holder comprises a plurality of boxes, each of said boxes having a drawer being slidably coupled thereto, each of said boxes having a front end and a peripheral wall, said front end being open, said peripheral wall having a top side, a bottom side and a first lateral side, said drawer sliding outwardly from said front end, said drawer having a front wall, said front wall covering said front end when said drawer is closed, said drawer being configured to contain the article of clothing.

2. The assembly according to claim 1, wherein said holder comprises a clothes hanger having a body and a hook, said body having a pair of upper members coupled to and extending away from a lower member, said body being configured to have the article of clothing suspended therefrom, said hook extending upwardly from said body wherein said hook is configured to be suspended from a support.

3. (canceled)

4. The assembly according to claim 1, wherein said top side has a plurality of wells extending downwardly therein, each of said wells being positioned adjacent to an associated one of four corners of said box.

5. The assembly according to claim 4, wherein each of said boxes includes a plurality of couplers, each of said couplers being coupled to said bottom side, each of said couplers being positioned adjacent to an associated one of said four corners, each of said couplers on one of said boxes being complementary with respect to each of said wells on one of said boxes thereby facilitating said boxes to be stacked.

6. The assembly according to claim 1, wherein said tracking unit comprises a control circuit being coupled to said holder, said control circuit including an electronic memory, said electronic memory storing the information, said control circuit being configured to convert the information into a barcode.

7. The assembly according to claim 6, further comprising a transceiver being coupled to said holder, said tracking unit being electrically coupled to said control circuit, said transceiver being configured to be in electrical communication with an extrinsic electronic device thereby facilitating said electronic memory to receive the information, said control circuit receiving a location command from the extrinsic electronic device.

8. The assembly according to claim 6, further comprising a light emitter being coupled to said holder wherein said light emitter is configured to be visible to the user, said light emitter being electrically coupled to said control circuit wherein said light emitter is configured to emit light when said control circuit receives the location command thereby facilitating the user to visually locate said holder.

9. The assembly according to claim 6, further comprising a display being coupled to said holder, said display being electrically coupled to said control circuit wherein said display is configured to display the barcode thereby facilitating the barcode to be scanned into an inventory tracker.

10. The assembly according to claim 9, further comprising a power supply being positioned within said holder, said power supply being electrically coupled to said control circuit, said power supply comprising at least one battery.

11. An inventory tracking assembly comprising:
a holder being configured to restrain an article of clothing, said holder comprising:
a clothes hanger having a body and a hook, said body having a pair of upper members coupled to and extending away from a lower member, said body being configured to have the article of clothing suspended therefrom, said hook extending upwardly from said body wherein said hook is configured to be suspended from a support, and
a plurality of boxes, each of said boxes having a drawer being slidably coupled thereto, each of said boxes having a front end and a peripheral wall, said front end being open, said peripheral wall having a top side, a bottom side and a first lateral side, said drawer sliding outwardly from said front end, said drawer having a front wall, said front wall covering said front end when said drawer is closed, said drawer being configured to contain the article of clothing, said top side having a plurality of wells extending downwardly therein, each of said wells being positioned adjacent to an associated one of four corners of said box, each of said boxes including a plurality of couplers, each of said couplers being coupled to said bottom side, each of said couplers being positioned adjacent to an associated one of said four corners, each of said couplers on one of said boxes being complementary with respect to each of said wells on one of said boxes thereby facilitating said boxes to be stacked; and
a tracking unit being coupled to said holder, said tracking unit being configured to store information pertaining to the article of clothing, said tracking unit displaying the information wherein said tracking unit is configured to communicate the information to a user thereby facilitating the article of clothing to be tracked and identified, said tracking unit comprising:
a control circuit being coupled to said holder, said control circuit including an electronic memory, said electronic memory storing the information, said control circuit being configured to convert the information into a barcode,
a transceiver being coupled to said holder, said tracking unit being electrically coupled to said control circuit, said transceiver being configured to be in electrical communication with an extrinsic electronic device thereby facilitating said electronic memory to receive the information, said control circuit receiving a location command from the extrinsic electronic device,
a light emitter being coupled to said holder wherein said light emitter is configured to be visible to the user, said light emitter being electrically coupled to said control circuit wherein said light emitter is configured to emit light when said control circuit receives the location command thereby facilitating the user to visually locate said holder,
a display being coupled to said holder, said display being electrically coupled to said control circuit wherein said display is configured to display the barcode thereby facilitating the barcode to be scanned into an inventory tracker, and
a power supply being positioned within said holder, said power supply being electrically coupled to said control circuit, said power supply comprising at least one battery.
